(19) United States
(12) Patent Application Publication
(10) Pub. No.: US 2015/0260347 A1
(43) Pub. Date: Sep. 17, 2015

(54) GAS CONTAINING TANK

(71) Applicant: TOYOTA JIDOSHA KABUSHIKI KAISHA, Toyota-shi (JP)

(72) Inventor: Keigo NOGUCHI, Nissin-shi (JP)

(73) Assignee: TOYOTA JIDOSHA KABUSHIKI KAISHA, Toyota-shi (JP)

(21) Appl. No.: 14/644,928

(22) Filed: Mar. 11, 2015

(30) Foreign Application Priority Data
Mar. 14, 2014 (JP) 2014-051561

(51) Int. Cl. F17C 13/12; F17C 13/04

(52) U.S. Cl. CPC F17C 13/123; F17C 13/04

(57) ABSTRACT

A gas containing tank includes: a tank body that contains a gas; a safety valve that discharges the gas contained in the tank body when being heated above a predetermined temperature; a conduction member that is provided outside the tank body, and transfers heat to the safety valve; and a heat insulation member that covers at least a part of the conduction member, and has higher heat insulation than that of the conduction member. The predetermined temperature is lower than 600° C., and the heat insulation member has a heat-resistance temperature lower than 60° C. and higher than the predetermined temperature.

### INCORPORATION BY REFERENCE

The disclosure of Japanese Patent Application No. 2014-051561 filed on Mar. 14, 2014 including the specification, drawings and abstract is incorporated herein by reference in its entirety.

### BACKGROUND OF THE INVENTION

1. Field of the Invention

The invention relates to a gas containing tank.

2. Description of Related Art

In a tank that contains a compressed gas and the like, in the case that a temperature of the tank rises for some reason, a method for providing a safety valve that discharges the gas inside the tank along with the rise of the temperature is known as a method for discharging the gas inside the tank (see Japanese Patent Application Publication No. 2005-315294 (JP 2005-315294 A), for example).

The technique in JP 2005-315294 A is a technique in which a good heat conduction unit is provided at the safety valve so that the safety valve can be properly heated even in the case that heat is generated at a position far away from the safety valve.

However, in the technique in JP 2005-315294 A, when the good heat conduction unit transfers heat to the safety valve, discharge of heat will occur at a part where the good heat conduction unit is in contact with the air. Thus, means for transferring heat to the safety valve more efficiently is expected as means for transferring heat to the safety valve. The expectation has a more prominent tendency as a heat generation source is farther from the safety valve.

### SUMMARY OF THE INVENTION

A first aspect of the invention relates to a gas containing tank. The gas containing tank includes: a tank body that contains a gas; a safety valve that is configured to discharge the gas contained in the tank body when being heated above a predetermined temperature; a conduction member that is provided outside the tank body, and transfers heat to the safety valve; and a heat insulation member that covers at least a part of the conduction member, and has higher heat insulation than that of the conduction member. The predetermined temperature is lower than 600° C., and the heat insulation member has a heat-resistance temperature lower than 600° C. and higher than the predetermined temperature. According to this structure, when the conduction member transfers heat, discharge of heat to the air can be inhibited through the heat insulation member. Thus, the conduction member can efficiently transfer heat to the safety valve. Moreover, since the heat-resistance temperature of the heat insulation member is lower than 600° C., when heat higher than 600° C. is transferred to the heat insulation member, this part of the heat insulation member is melted, and the heat is transferred to the conduction member. On the other hand, since the heat-resistance temperature of the heat insulation member is higher than the predetermined temperature, even in the case that a temperature higher than the predetermined temperature is transferred to the heat insulation member, the heat insulation member will be not melted. Thus, the conduction member can efficiently transfer heat to the safety valve.

The heat insulation member may be formed by non-foaming rubber or non-foaming resin. According to this structure, as compared with the case that the heat insulation member is foaming resin, when heat higher than 600° C. is transferred to the heat insulation member, this part of the heat insulation member is rapidly melted. Thus, the conduction member can efficiently transfer heat to the safety valve.

It is also permitted that the part of the conduction member is arranged along a main body of the tank body. According to this structure, heat dissipation can be inhibited at the part where the heat insulation member is arranged along the main body of the tank body. Moreover, an unnecessary heat input to the tank body can be prevented.

The heat insulation member may also cover an entire surface of the conduction member. According to this structure, when the conduction member transfers heat, discharge of heat to the air can be further inhibited through the heat insulation member. Thus, the conduction member can efficiently transfer heat to the safety valve.

The invention can be realized in various manners, e.g., the invention can be realized in a manner such as a method for manufacturing a gas containing tank, a computer program for achieving the manufacturing method or a storage medium in which the computer program is stored.

### BRIEF DESCRIPTION OF THE DRAWINGS

Features, advantages, and technical and industrial significances of exemplary embodiments of the invention will be described below with reference to the accompanying drawings, in which like numerals denote like elements, and wherein:

FIG. 1 is an explanatory view showing the schematic structure of a tank 50 in the first embodiment of the invention;

FIG. 2 is an explanatory view showing the sectional structure of the tank 50 in the first embodiment of the invention;

FIG. 3 is an explanatory view showing the section of a heat transfer portion 15;

FIGS. 4A-4C are views showing a tank when a heat insulation member 40 is not used;

FIGS. 5A-5C are views showing a tank 50 provided with a heat insulation member 40;

FIG. 6 is an explanatory view showing the schematic structure of the section of a tank 60 in the second embodiment of the invention; and

FIG. 7 is an explanatory view showing the schematic structure of a tank 70 in the third embodiment of the invention.

### DETAILED DESCRIPTION OF EMBODIMENTS

### A. First Embodiment

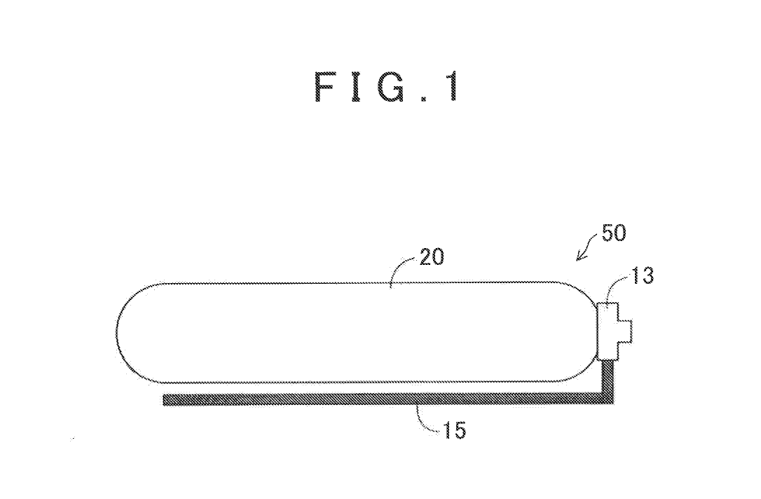

FIG. 1 is an explanatory view showing the schematic structure of a tank 50 in the first embodiment of the invention. In this embodiment, the tank 50 is a gas containing tank for a fuel cell. Hydrogen can be listed as an example of the gas. The tank 50 has a tank body 20, a safety valve 13 and a heat transfer portion 15.

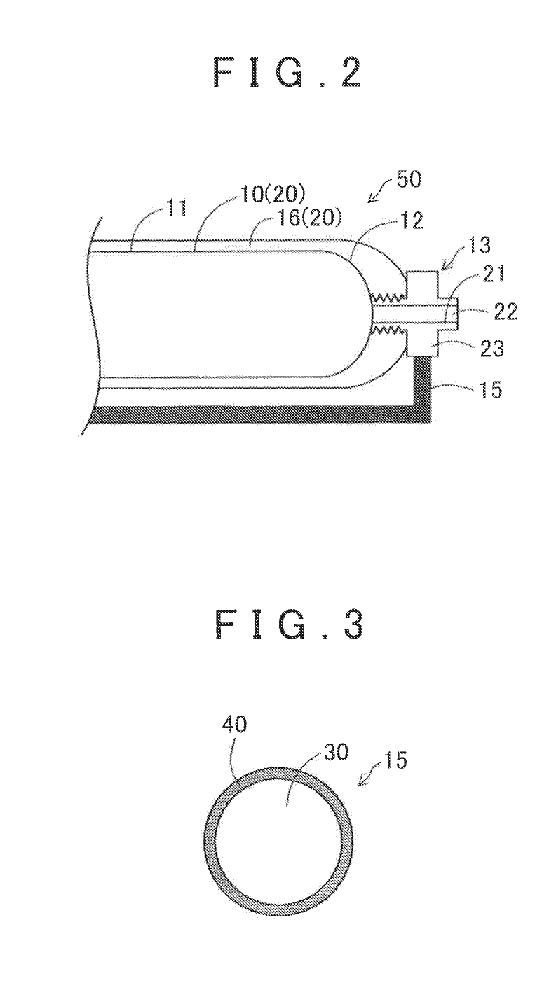

FIG. 2 is an explanatory view showing the sectional structure of the tank 50 in the first embodiment of the invention. The tank body 20 contains a gas therein, and has a liner 10 and a fiber layer 16.

The liner 10 is a sealed container for containing a gas to be supplied to the fuel cell. The liner 10 has a substantially cylindrical main body 11 formed at the central part and a substantially hemispheric dome portion 12 formed continuously from both ends of the main body 11. A high-strength aluminum material or stainless steel material, or a resin material can be used as the material of the liner 10.

The fiber layer 16 is a layer that covers the liner 10 in order to improve the strength of the liner 10, and is formed by fibers. In this embodiment, the fiber is a carbon fiber.

The safety valve 13 has a safety valve body 23 and a locking portion 22 filled in a gas discharge path 21. The safety valve 13 is provided at a front end of the dome portion 12 of the liner 10.

The gas discharge path 21 is a path that connects the interior of the liner 10 with the exterior of the liner 10. The gas discharge path 21. is normally filled with the locking portion 22 formed by an alloy. Thus, the gas discharge path 21 is normally sealed through the locking portion 22. However, when the safety valve 13 is heated at or above a predetermined temperature T, the locking portion 22 is melted. As a result, the gas discharge path 21 is opened, and the safety valve 13 discharges the gas contained in the tank body 20. It should be noted that the predetermined temperature T is a temperature at or above which the safety valve 13 is heated to discharge the gas. The predetermined temperature T is lower than 600° C. In this embodiment, the predetermined temperature T is properly selected from the range of 100-120° C. Moreover, in this embodiment, the locking portion 22 is formed using a bismuth alloy. Furthermore, although not shown in the drawings, a gas tube for supplying a gas to a fuel cell and the like is provided at the tank as a member different from the heat transfer portion.

FIG. 3 is an explanatory view showing the section of the heat transfer portion 15. The heat transfer portion 15 has a conduction member 30 and a heat insulation member 40 that covers the conduction member 30.

The conduction member 30 is provided outside the body of the tank 50. The conduction member 30 extends from the safety valve 13 to a side opposite the side on which the safety valve 13 is provided. The conduction member 30 is fixed by the safety valve 13 and a jig such as a clamp, and transfers heat to the safety valve 13. The conduction member 30 is formed by a material having heat conductivity. In this embodiment, the conduction member 30 is formed by a member having heat conductivity equal to or higher than that of the safety valve 13. In this embodiment, the conduction member 30 uses a heat pipe. It should be noted that metal such as aluminum or steel, or resin can be also used as the conduction member 30.

The heat insulation member 40 covers at least a part of the conduction member 30, and has higher heat insulation than that of the conduction member 30. in this embodiment, the heat insulation member 40 is formed so as to cover an entire surface of the conduction member 30, That is, the conduction member 30, except for a part connected with the safety valve 13, is covered by the heat insulation member 40. In this embodiment, a part of the conduction member 30 is arranged along the main body of the tank 50, and the heat insulation member 40 at least covers a part serving as a part of the conduction member 30 and arranged along the main body of the tank 50 (see FIG. 1). Thus, the part serving as a part of the conduction member and arranged along the main body of the tank body is covered by the heat insulation member, so that heat dissipation can be inhibited at the part arranged along the main body of the tank body. Moreover, an unnecessary heat input to the tank body can be prevented.

The heat-resistance temperature of the heat insulation member 40 is lower than 600° C. and higher than the predetermined temperature T. Here, the heat-resistance temperature of the heat insulation member 40 is a temperature at which the heat insulation member 40 starts melting. In this way, since the heat-resistance temperature of the heat insulation member is lower than 600° C., in the case that heat higher than 600° C. is transferred to the heat insulation member, this part of the heat insulation member starts melting, and the heat is transferred to the conduction member. On the other hand, since the heat-resistance temperature of the heat insulation member is higher than the predetermined temperature T, even in the case that a temperature lower than 600° C. and higher than the predetermined temperature T is transferred to the heat insulation member, the heat insulation member will not be melted. Thus, the conduction member can efficiently transfer heat to the safety valve. It should be noted that the temperature of the flame can be, for example, 600° C. to 900° C.

The heat insulation member 40 preferably uses non-foaming rubber or non-foaming resin. In this embodiment, silicone is used as the heat insulation member 40. in the case that the non-foaming rubber or the non-foaming resin is used as the heat insulation member 40, as compared with the case that the foaming resin is used as the heat insulation member 40, this part of the heat insulation member is rapidly melted when the heat insulation member 40 is heated at or above 600° C. Thus, in the case that the non-foaming rubber or the non-foaming resin is used as the heat insulation member 40, the conduction member 30 can efficiently transfer heat to the safety valve 13. It should be noted that with respect to the foaming resin, since the resin contains bubbles, the heat conductivity is low, and the resin will not be rapidly melted. The foaming resin is the foaming or porous resin formed by finely scattering a gas in the resin. The non-foaming resin is the resin other than the foaming resin.

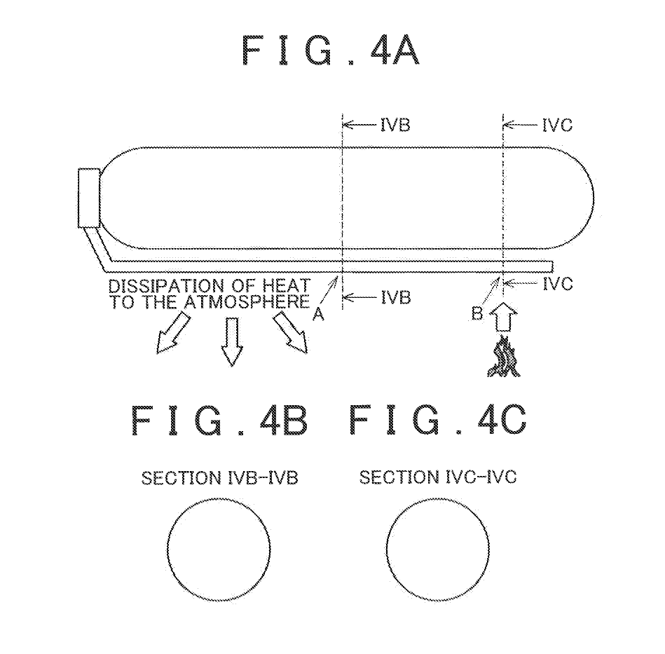

FIGS. 4A-4C are views showing the tank when the heat insulation member 40 is not used. It is assumed that heat of or above 600° C. is transferred from a part B. In this case, before the heat of the part B is transferred to a part A, the heat is discharged to the atmosphere. Thus, it can be considered that the temperature of a part of the section IVB-IVB is lower than the temperature of a part of the section IVC-IVC.

FIG. 4B shows the conduction member 30 at the section IVB-IVB, and FIG. 4C shows the conduction member 30 at the section IVC-IVC. In these two sections, since the heat insulation member 40 is not provided, no difference exists.

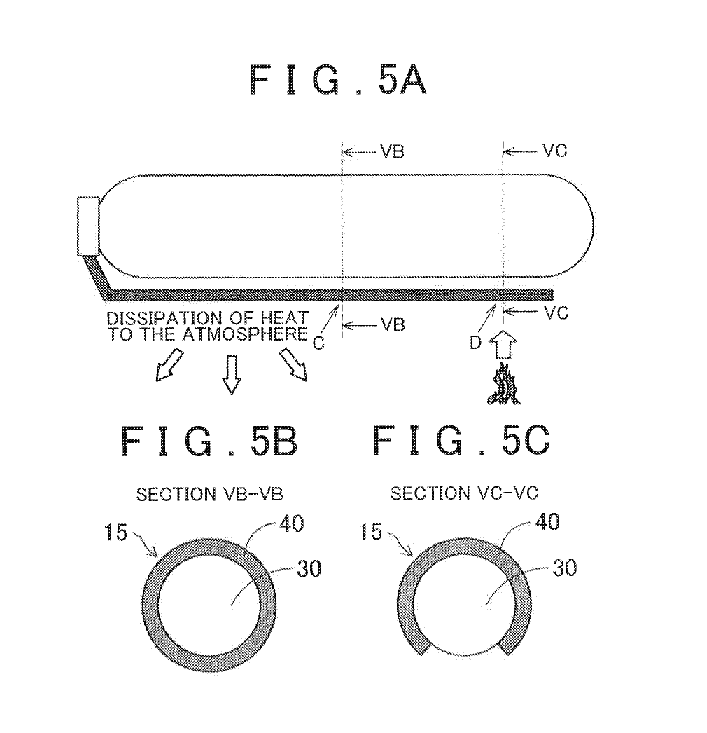

FIGS. 5A-5C are views showing the tank 50 provided with the heat insulation member 40. It is assumed that heat of or above 600° C. is transferred from a part D to the heat transfer portion 15. In this case, after a part of the heat insulation member 40 excessively heated at or above 600° C. is melted, the conduction member 30 is exposed. As a result, the heat is transferred from the exposed part of the conduction member 30. Then, the heat of the part D is transferred to a part C.

FIG. 5B shows a part of the heat transfer portion 15 at the section VB-VB, and FIG. 5C shows a part of the heat transfer portion 15 at the section VC-VC. FIG. 5C shows that a part of the conduction member 30 is exposed for the reason that a part of the heat insulation member 40 heated at or above 600° C. is melted.

According to the tank 50, discharge of heat from the conduction member 30 to the atmosphere is inhibited through the heat insulation member 40. Thus, as compared with the tank shown in FIGS. 4A-4C, the conduction member can efficiently transfer heat to the safety valve.

### B. Second Embodiment

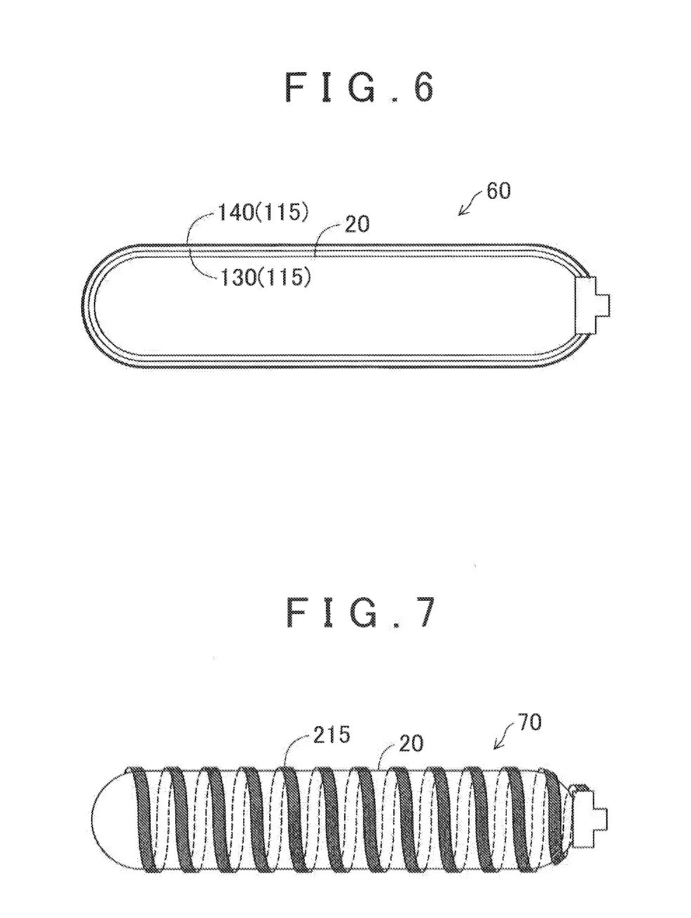

FIG. 6 is an explanatory view showing the schematic structure of the section of a tank 60 in the second embodiment of the invention. The tank 60 in the second embodiment is different from the tank 50 in the first embodiment in that it uses a heat transfer portion 115 in place of the heat transfer portion 15 to cover the entire surface of the tank body 20, and the tank 60 and the tank 50 are the same in the points other than the above one.

In the tank 60 in the second embodiment, a conduction member 130 covers the tank body 20, and a heat insulation member 140 covers the conduction member 130. It should be noted that a gap exists between the tank body 20 and the conduction member 130. In this way, in the case that heat of or above 600° C. is generated around the tank 60, the heat can be transferred to the safety valve 13 more reliably.

### C. Third Embodiment

FIG, 7 is an explanatory view showing the schematic structure of a tank 70 in the third embodiment of the invention. The tank 70 in the third embodiment is different from the tank 50 in the first embodiment in that it uses a heat transfer portion 215 in place of the heat transfer portion 15 to be spirally formed around the tank body 20, and the tank 70 and the tank 50 are the same in the points other than the above one. it should be noted that a gap exists between the tank body 20 and the heat transfer portion 215. In this way, in the case that heat above 600° C. is generated around the tank 60, as compared with the tank 50 in the first embodiment, the heat can be transferred to the safety valve 13 more reliably.

### Modified Embodiments

### D1. Modified Embodiment 1

In the embodiments, a structure that the heat insulation member 40 covers the entire surface of the conduction member 30 is formed. However, the invention is not limited thereto. It is permitted as long as the heat insulation member 40 covers a part of the conduction member 30. In this way, as compared with the case that the heat insulation member 40 does not cover the conduction member 30, heat dissipation to the atmosphere can be inhibited. For example, a structure that the heat insulation member 40 is not provided at a part having high probability of generating heat but is provided at the other part of the conduction member 30 can be listed as the structure that the heat insulation member 40 covers a part of the conduction member 30. In the case of this structure, when heat is transferred from the part where the heat insulation member 40 is not provided, the heat is rapidly transferred to the conduction member 30 to be thereby rapidly transferred from the conduction member 30 to the safety valve 13.

### D2. Modified Embodiment 2

In the embodiments, there is one conduction member 30. However, the invention is not limited thereto, and there may be also multiple conduction members for transferring heat to the safety valve 13. Heat can be transferred to the safety valve 13 more reliably by providing a plurality of conduction members.

### D3. Modified Embodiment 3

In the embodiments, the conduction member 30 is formed into a substantially cylindrical shape. However, the invention is not limited thereto, and the conduction member 30 can be also formed into a plate shape or the like.

The invention is not limited to the above embodiments or modified embodiments, and the invention can be realized in various structures within the scope of not breaking away from its purposes. For example, the technical features in the embodiments and the modified embodiments can be properly substituted and combined.

What is clamed is:

1. A gas containing tank, comprising:
a tank body that contains a gas;
a safety valve that is configured to discharge the gas contained in the tank body when being heated at or above a predetermined temperature, the predetermined temperature being lower than 600° C.;
a conduction member that is provided outside the tank body, and transfers heat to the safety valve; and
a heat insulation member that covers at least a part of the conduction member, and has higher heat insulation than that of the conduction member, the heat insulation member having a heat-resistance temperature lower than 600° C. and higher than the predetermined temperature.

2. The gas containing tank according to claim 1, wherein the heat insulation member is formed by non-foaming rubber or non-foaming resin.

3. The gas containing tank according to claim 1, wherein the part of the conduction member is arranged along a main body of the tank body.

4. The gas containing tank according to claim 1, wherein the heat insulation member covers an entire surface of the conduction member.

5. The gas containing tank according to claim 1, wherein the predetermined temperature is 100° C.

6. The gas containing tank according to claim 5, wherein the predetermined temperature is 120° C.
